(19) United States
(12) Patent Application Publication
(10) Pub. No.: US 2020/0063275 A1
(43) Pub. Date: Feb. 27, 2020

(54) SURFACE MODIFIED ELECTRODES FOR ELECTROCHEMICAL SYNGAS RODUCTION

(71) Applicant: Toyota Motor Engineering & Manufacturing North America, Inc., Plano, TX (US)

(72) Inventors: Hongfei Jia, Ann Arbor, MI (US); Kenneth James McDonald, Whitmore Lake, MI (US)

(73) Assignee: Toyota Motor Engineering & Manufacturing North America, Inc., Plano, TX (US)

(21) Appl. No.: 16/667,292

(22) Filed: Oct. 29, 2019

Related U.S. Application Data
(63) Continuation of application No. 14/068,291, filed on Oct. 31, 2013, now abandoned.

(51) Int. Cl. C25B 11/04; C25B 1/00; C25B 1/02

(52) U.S. Cl. CPC C25B 11/0405; C25B 11/0447; Y02E 60/366; C25B 1/00; C25B 1/02; C25B 11/0415

(57) ABSTRACT

A process for electrochemical reduction of carbon dioxide and water forming carbon monoxide and hydrogen comprising the steps of; providing a metal substrate formed of a metal having a low carbon monoxide bonding strength; forming a self-assembled monolayer bonded to the metal substrate wherein the self-assembled monolayer includes an organic ligand having a surface end having a reactive group bonded to the metal substrate and an opposing end including an organic functional group regulating a ratio of reaction products; contacting carbon dioxide and water with the electrode having the self assembled monolayer forming carbon monoxide and hydrogen; wherein a selectivity of reaction products of carbon monoxide and hydrogen produced by the electrode is regulated relative to a bare metal substrate.

### CROSS-REFERENCE TO RELATED APPLICATIONS

This application is a continuation of U.S. patent application Ser. No. 14/068,291 filed Oct. 31, 2013, which is incorporated herein by reference in its entirety including the specification, drawings and abstract.

### FIELD OF THE INVENTION

The invention relates to electrodes for carbon dioxide reduction and with more particularity to electrodes having a self-assembled monolayer applied thereon for carbon dioxide reduction.

### BACKGROUND OF THE INVENTION

Fossil fuels are a finite resource that is utilized for various functions such as a fuel source or feed stock for various products. The burning of fossil fuels increases the amount of CO₂ in the environment. Electrolysis cells may be utilized for electrochemical reduction of CO₂ in aqueous medium to produce a variety of products such as H₂, CO, alcohols, formic acid, methane and short-chain alkanes. Of these products, the mixture of H₂ and CO (syngas) is highly desired because it can serve as feedstock to commercial Fischer-Tropsch processes for the production of liquid hydrocarbons. Selectively producing H₂ and CO at a controlled ratio would benefit the Fischer-Tropsch process.

Although many studies have been conducted in searching for highly active catalysts for CO₂ reduction, product selectivity control remained a challenge that needs to be solved. There is therefore a need in the art for an electrode that may regulate or control the product selectivity of H₂ and CO for CO₂ reduction. There is also a need in the art for an electrode that may regulate or control the activity of the electrode.

### SUMMARY OF THE INVENTION

In one aspect, there is disclosed a process for electrochemical reduction of carbon dioxide and water forming carbon monoxide and hydrogen comprising the steps of: providing a metal substrate formed of a metal having a low carbon monoxide bonding strength; forming a self-assembled monolayer bonded to the metal substrate wherein the self-assembled monolayer includes an organic ligand having a surface end having a reactive group bonded to the metal substrate and an opposing end including an organic functional group regulating a ratio of reaction products; contacting carbon dioxide and water with the electrode having the self assembled monolayer forming carbon monoxide and hydrogen; wherein a selectivity of reaction products of carbon monoxide and hydrogen produced by the electrode is regulated relative to a bare metal substrate.

### BRIEF DESCRIPTION OF THE DRAWINGS

FIG. 1 is a schematic representation of a self-assembled monolayer attached to a metal substrate;

FIG. 2 is a CV plot of a gold metal substrate having a self-assembling monolayer having ligands attached with the ligands including various organic functional groups and a measurement of the water contact angle for the ligands including various organic functional groups;

FIG. 3 is a CV plot of a silver metal substrate having a self-assembling monolayer having ligands attached with the ligands including various organic functional groups;

FIG. 4 is a plot of the potentiostatic polarization of silver substrates having a self-assembling monolayer having ligands attached with the ligands including various organic functional groups;

FIG. 5 is gas chromatography plots of silver substrates having a self-assembling monolayer having ligands attached with the ligands including various organic functional groups and a percentage of hydrogen and carbon monoxide in a gas phase product;

FIG. 6 are plots of the ratio of carbon monoxide to hydrogen for silver and gold substrates having a self-assembling monolayer having C2 and C11 length ligands attached with the ligands including various organic functional groups;

FIG. 7 are plots of the activity for gold substrates having a self-assembling monolayer having C2 and C11 length ligands attached with the ligands including various organic functional groups;

FIG. 8 is a pictorial diagram of an experimental electrochemical cell including a wire working electrode.

### DETAILED DESCRIPTION OF THE PREFERRED EMBODIMENTS

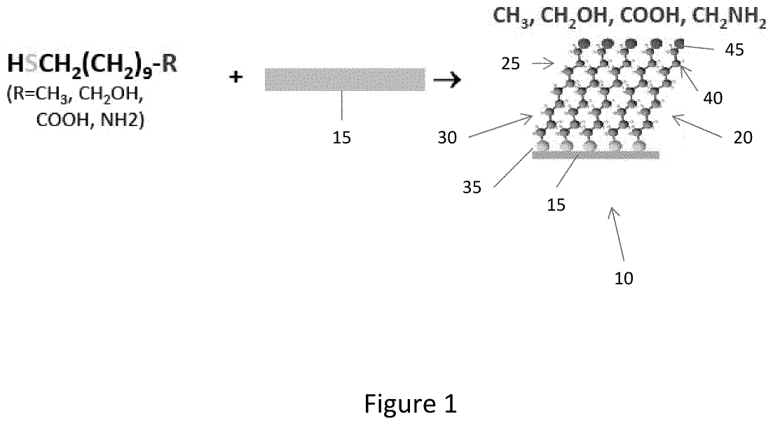

Referring to FIG. 1, there is shown a diagram of an electrode 10 for electrochemical reduction of carbon dioxide and water forming carbon monoxide and hydrogen. The electrode includes a metal substrate 15. A self-assembled monolayer 20 is bonded to the metal substrate 15.

In one aspect, the reaction products of the electrochemical reduction of carbon dioxide and water may produce a syngas formed of carbon monoxide and hydrogen. The syngas may be utilized in a Fischer-Tropsch Process as detailed by the reaction below to produce various hydrocarbon materials. By altering the selectivity of the reaction products produced by the electrode, the efficiency and productivity for a desired hydrocarbon from the Fischer-Tropsch Process can be increased. For example, it may be desirable to have a ratio of 2:1 of hydrogen to carbon monoxide for the synthesis of a liquid hydrocarbon fuel, such as gasoline.

(2n+1)H₂+n CO→CnH(2n+2)+n H₂O

The metal substrate 15 may be formed of a metal having a low carbon monoxide bonding strength. In one aspect the bond strength may he characterized such that the CO adsorption energy is less than 1 eV. In one aspect, the metals may be selected from Au, Ag, Zn, Pd, and Ga.

In one aspect, the self-assembled monolayer 20 includes an organic ligand 25 having a surface end 30 having a reactive group 35 bonded to the metal substrate 15 and an opposing end 40 including an organic functional group 45. The organic ligand may have a length of carbon units of from C2 to C20. The ligand may be formed of alkane chains or aromatic chains.

In one aspect, the reactive group forms a covalent bond with the metal substrate. The reactive group may include a thiol group. The thiol groups of the reactive group may react with the surface of the metal substrate to form a covalent bond. The ligands are assembled on the metal substrate as a monolayer as depicted in FIG. 1.

As detailed above, the opposing end may include an organic functional group that may be selected from CH₃, OH, COOH and NH₂. In one aspect, the organic functional group may be exposed to an aqueous electrolyte that is saturated with carbon dioxide. The various organic functional groups may affect various properties of the electrode including the hydrophobicity as well as the charge at the electrolyte interface. The changes in electrode properties may be utilized to regulate or modify the selectivity and activity of the electrode.

### EXAMPLES

Gold (Au) and Silver (Ag) thin film electrodes (100 nm in thickness) were prepared by LGA Thin Film Inc. (Santa Clara, Calif.) using sputtering. To increase adhesion, a 20-nm layer of Ti was pre-sputtered on glass substrate prior to the deposition of Au or Ag films. Ag wire electrodes (1.0 mm in diameter), Thio-based ligands, potassium bicarbonate (KHCO₃) and ethanol were purchased from Sigma Aldrich.

Assembly of ligands on metal substrate of the electrode includes substrate cleaning, preparation of ligand solution, incubation for assembly and post-assembly rinsing. To clean the metal substrate surface, the electrodes were sonicated first in DI water (5 min, twice) and then in ethanol (5 min, twice). For the Ag wire electrode, the surface was mechanically polished with 50 nm Al2O3 prior to the cleaning procedures.

Thio ligands with different organic functional groups were dissolved in ethanol at a concentration of 5 mM in 20-ml glass vials. C-2 and C-11 ligands were utilized in the following examples as will be discussed in more detail below. During the assembly process, all electrodes were immersed and incubated in ligand solution at room temperature for at least 24 hrs. After the reaction, the electrodes were first rinsed with ethanol and then sonicated in ethanol and DI water (5 min, twice for each rinse) and then dried in a vacuum oven at room temperature. The resulting electrodes were stored in sealed glass vials filled with argon.

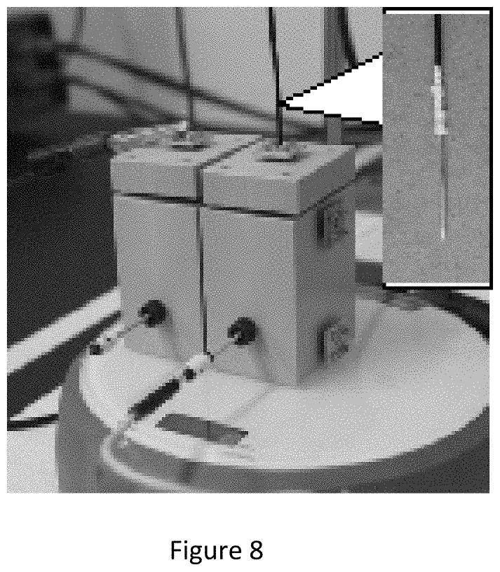

Electrochemical analysis was conducted in a two chamber cell as shown in FIG. 8, using Pt mesh as counter and Ag/AgCl as reference electrodes, respectively. KHCO₃ (0.1 M) was used as an electrolyte. CO₂ was purged through the electrolyte for at least 15 min before starting the experiment.

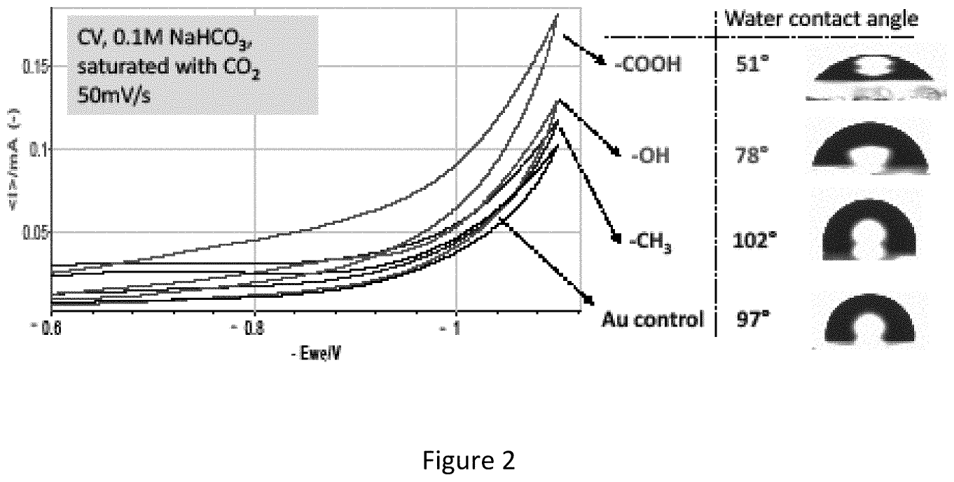

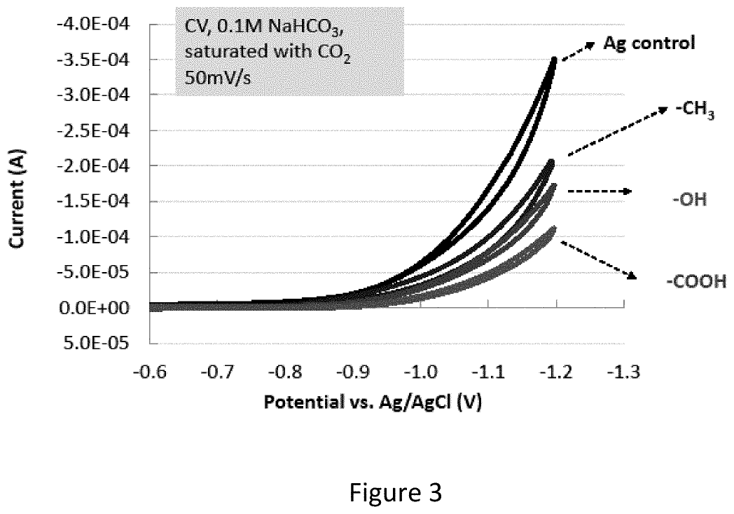

Referring to FIGS. 2 and 3, cyclic voltammetry studies and water contact angle measurements were performed on thin film electrodes for Au and Ag metal substrates. Ag wire electrodes were utilized for potentiostatic electrolysis and GC analysis. The anode and cathode chambers were separated by a piece of Nafion 117. In the testing, 25 ml of electrolyte was filled into the anode chamber, which allowed 5.5 ml of gas phase volume in the headspace.

Formation of self-assembled monolayers (SAM) was evident, based on the results of water contact angle measurements as detailed in FIG. 2. Ligands with —COOH and —CH₃ groups gave the most hydrophilic and the most hydrophobic surfaces, respectively. Cyclic voltammetry, as shown in FIG. 2 showed that the electrode modified with SAM-COOH produced higher catalytic current in comparison to the other SAM-modified surfaces and the bare Au control.

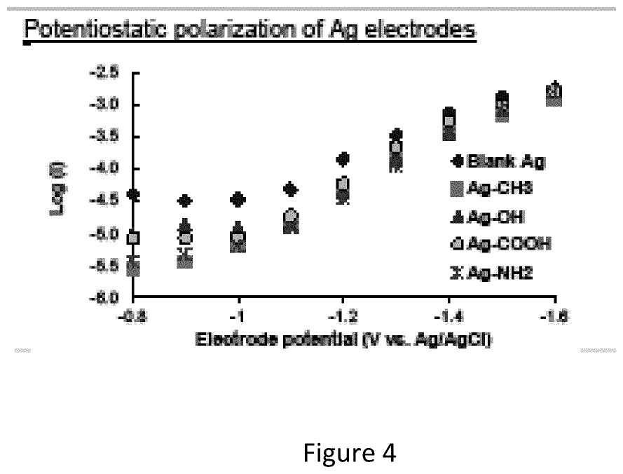

C-2 and C-11 ligands were also applied to the modification of Ag wire electrodes, which were then used for bulk electrolysis. To examine the change of electrode activity as a response to the surface modification, potentiostatic electrolysis was conducted at potentials ranging from −0.8 to −1.6 V (vs. Ag/AgCl). Because the SAM ligands have non-conductive alkane chains, it can be expected that the modified electrodes would be less active than the blank control, as shown in FIG. 4. This result confirms ligand attachment to Ag surface. The SAM modified electrodes were less active than the blank Ag control, indicating the ligands might have created insulating barriers for electron transfer to affect the activity of the electrodes such that the activity may be regulated or controlled.

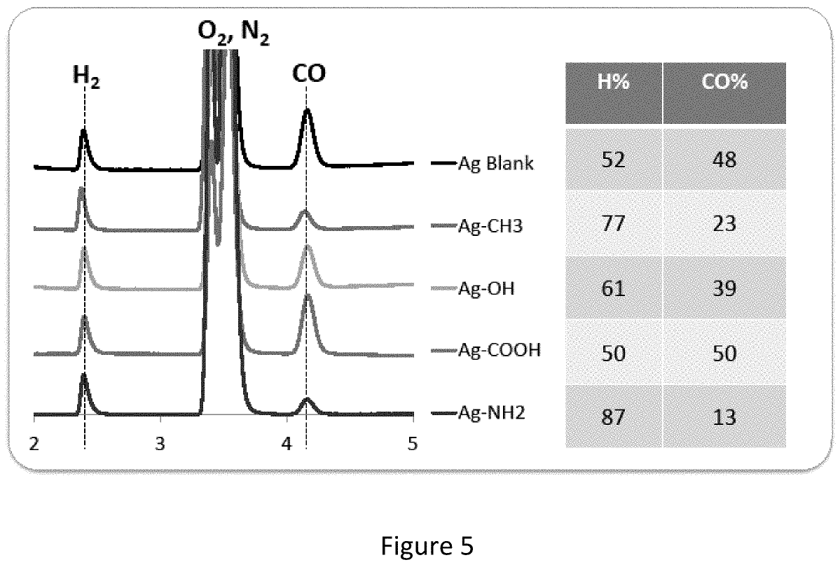

The amount of H₂ and CO product in the electrochemical cell headspace was measured by gas chromatography (GC) after a total pass of one coulomb of charge. As shown in FIG. 5. SAM-modification has significant influences on catalyst selectivity. The calculated ratios are summarized in the table of FIG. 5 for a C-11 ligand having various organic functional groups. Interestingly, the ratio of H₂ to CO increases from —COOH to —CH₂OH and —CH₃, correlating well with surface hydrophobility. Additionally, the —NH₂ functional group showed the highest ratio of H₂ to CO. These results demonstrate that it is feasible to control or regulate product selectivity by utilizing a SAM modified electrode with various functional groups.

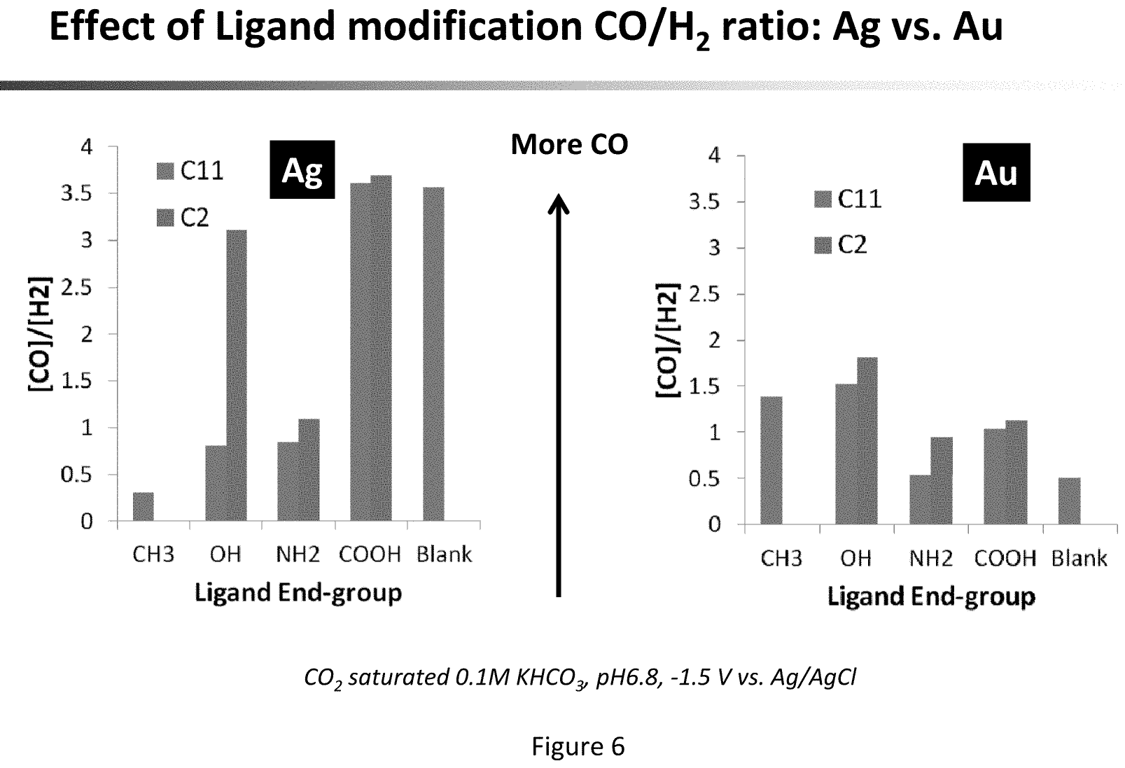

Referring to FIG. 6, there is shown a plot detailing the ratio of carbon monoxide to hydrogen for silver and gold metal substrates having SAM applied to the surfaces of the electrode and including various functional groups. Five plots include both C-2 and C-11 length ligands. The plots were generated utilizing the experimental apparatus described above with CO2 saturated 0.1M KHCO3 as an electrolyte at a pH of 6.8 at a constant potential of −1.5 V (vs. Ag/AgCl). As can be seen from the plots, the ligand length, metal substrate and the choice of organic functional group may be selected to regulate the selectivity of the electrode reaction products of carbon monoxide and hydrogen produced by the electrode.

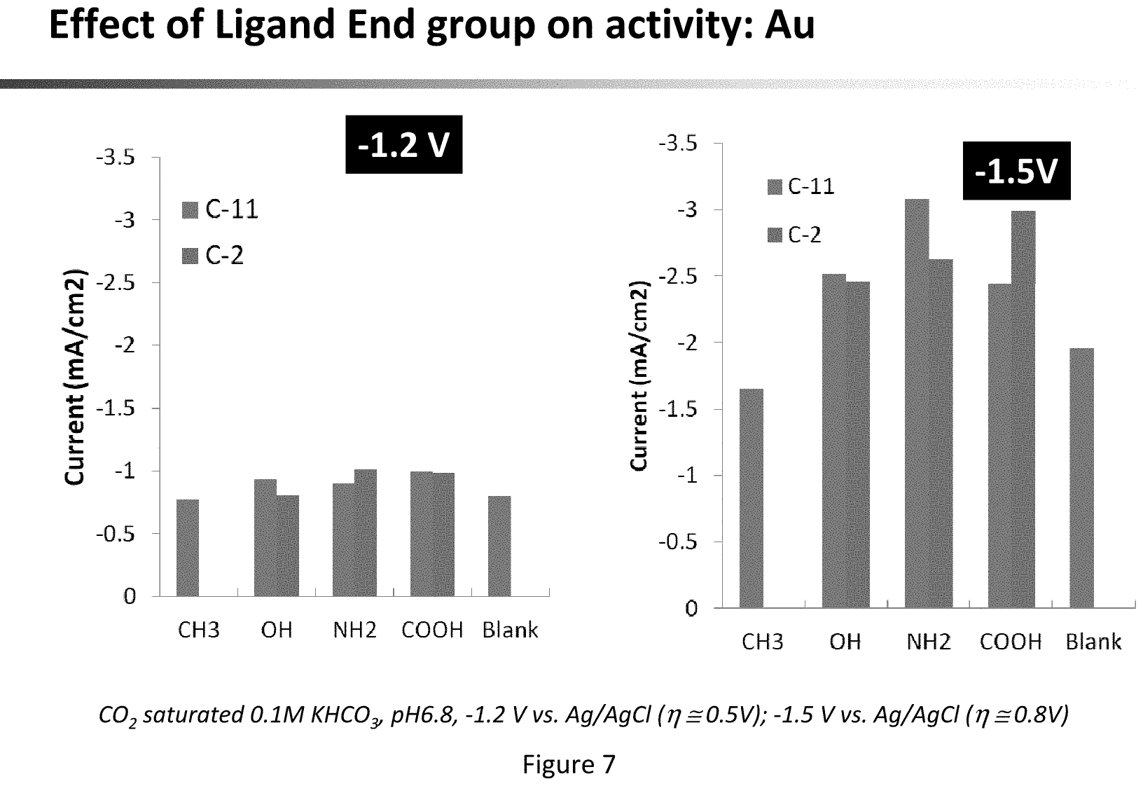

Referring to FIG. 7, there is shown a plot detailing the activity for gold metal substrates having SAM applied to the surfaces of the electrode and including various functional groups. The plots include both C-2 and C-11 length ligands. The plots were generated utilizing the experimental apparatus described above with CO2 saturated 0.1M KHCO3 as an electrolyte at a pH of 6.8 at a constant potential of −1.5 V and −1.2V (vs. Ag/AgCl). As can be seen from the plots, the ligand length, metal substrate and the choice of organic functional group may be selected to regulate the activity of the electrode.

The invention has been described in an illustrative manner. It is to be understood that the terminology, which has been used, is intended to be in the nature of words of description rather than limitation. Many modifications and variations of the invention are possible in light of the above teachings. Therefore, within the scope of the appended claims, the invention may be practiced other than as specifically described.

1. A process for electrochemical reduction of carbon dioxide and water forming carbon monoxide and hydrogen comprising the steps of:
providing a metal substrate formed of a metal having a low carbon monoxide bonding strength:
forming a self-assembled monolayer bonded to the metal substrate wherein the self-assembled monolayer includes an organic ligand having a surface end having a reactive group bonded to the metal substrate and an opposing end including an organic functional group regulating a ratio of reaction products:
contacting carbon dioxide and water with the electrode having the self assembled monolayer forming carbon monoxide and hydrogen;
wherein a selectivity of reaction products of carbon monoxide and hydrogen produced by the electrode is regulated relative to a bare metal substrate.

2. The process of claim 1 wherein the metal substrate is selected from Au, Ag, Zn, Pd, and Ga.

3. The process of claim 1 wherein the organic ligand has a length of from C2 to C20.

4. The process of claim 1 wherein the reactive group forms a covalent bond with the metal substrate.

5. The process of claim 4 wherein the reactive group is a thiol group.

6. The process of claim 1 wherein the organic functional group is selected from CH3, OH, COOH and NH2.

7. The process of claim 1 wherein the metal is silver, the organic ligand has a length of C11, the functional group is CH3 and the reaction product includes 77% hydrogen and 23% carbon monoxide.

8. The process of claim 1 wherein the metal is silver, the organic ligand has a length of C11, the functional group is OH and the reaction product includes 61% hydrogen and 39% carbon monoxide.

9. The process of claim 1 wherein the metal is silver, the organic ligand has a length of C11, the functional group is COOH and the reaction product includes 50% hydrogen and 50% carbon monoxide.

10. The process of claim 1 wherein the metal is silver, the organic ligand has a length of C11, the functional group is and NH2 and the reaction product includes 87% hydrogen and 13% carbon monoxide.

11. The process of claim 1 wherein the metal is silver, the organic ligand has a length of C2, the functional group is OH and the reaction product includes a CO/H2 ratio of 3.1 to 1.

12. The process of claim 1 wherein the metal is silver, the organic ligand has a length of C2, the functional group is COOH and the reaction product includes a CO/H2 ratio of 3.6 to 1.

13. The process of claim 1 wherein the metal is silver, the organic ligand has a length of C2, the functional group is and NH2 and the reaction product includes a CO/H2 ratio of 1.2 to 1.

14. The process of claim 1 wherein the metal is gold, the organic ligand has a length of C2, the functional group is OH and the reaction product includes a CO/H2 ratio of 1.7 to 1.

15. The process of claim 1 wherein the metal is gold, the organic ligand has a length of C2, the functional group is COOH and the reaction product includes a CO/H2 ratio of 1.2 to 1.

16. The process of claim 1 wherein the metal is gold, the organic ligand has a length of C2, the functional group is and NH2 and the reaction product includes a CO/H2 ratio of 0.9 to 1.

17. The process of claim 1 wherein the metal is gold, the organic ligand has a length of C11, the functional group is CH3 and the reaction product includes a CO/H2 ratio of 1.4 to 1.

18. The process of claim 1 wherein the metal is gold, the organic ligand has a length of C11, the functional group is OH and the reaction product includes a CO/H2 ratio of 1.5 to 1.

19. The process of claim 1 wherein the metal is gold, the organic ligand has a length of C11, the functional group is COOH and the reaction product includes a CO/H2 ratio of 1.3 to 1.

20. The process of claim 1 wherein the metal is gold, the organic ligand has a length of C11, the functional group is and NH2 and the reaction product includes a CO/H2 ratio of 0.6 to 1.
